(19) United States
(12) Patent Application Publication
(10) Pub. No.: US 2016/0051446 A1
(43) Pub. Date: Feb. 25, 2016

(54) DRUG CONTAINER CLOSURE FOR MOUNTING ON OPEN-TOPPED DRUG CONTAINER TO FORM DRUG RECONSTITUTION ASSEMBLAGE FOR USE WITH NEEDLELESS SYRINGE

(71) Applicant: MEDIMOP MEDICAL PROJECTS LTD, Ra'anana (IL)

(72) Inventors: Nimrod LEV, Savion (IL); Mordechai BUKHMAN, Netanya (IL)

(21) Appl. No.: 14/784,300

(22) PCT Filed: Apr. 3, 2014
(86) PCT No.: PCT/IL2014/050327

§ 371 Date: Oct. 14, 2015

(30) Foreign Application Priority Data
Apr. 14, 2013 (IL) 225734

(51) Int. Cl. A61J 1/20

(52) U.S. Cl. CPC A61J 1/2089; A61J 1/2051; A61J 1/2055; A61J 1/2096; A61J 1/1406

(57) ABSTRACT

A drug container closure for mounting on an open-topped drug container to form a ready-to-use drug reconstitution assemblage for use with a needleless syringe. The drug container closure includes a drug container stopper for sealing the drug container and a fluid transfer member with an integral needleless syringe connector and a puncturing cannula. The fluid transfer member is manually disposed along a diametric inverted L-shaped track pair from an initial non-puncturing position to a puncturing position. The inverted L-shaped track pair includes one-way snap members to prevent a user returning the fluid transfer member to an earlier position and indicating progress of the user activation.

### FIELD OF THE INVENTION

The invention relates to drug container closures for mounting on open-topped drug containers to form so-called ready-to-use drug reconstitution assemblages for use with needleless syringes. The drug container closures include a drug container stopper for sealing an open-topped drug container and a fluid transfer member with an integral needleless syringe connector and puncturing cannula.

### BACKGROUND OF THE INVENTION

Ready-to-use drug reconstitution assemblages including an open-topped drug container and a drug container closure having a fluid transfer member with an integral needleless syringe connector and puncturing cannula are known in the prior art. Exemplary prior art includes inter alia:

U.S. Pat. No. 4,576,211 to Valentini et al. entitled Safety device for connection of a syringe with the mouth or opening of a bottle containing a drug or a small tube for drug delivery from the syringe

U.S. Pat. No. 5,429,614 to Fowles et al. entitled Drug delivery system

U.S. Pat. No. 5,776,116 to Lopez et al. entitled Medical connector

U.S. Pat. No. 5,902,280 to Powles et al. entitled Aspiration needle apparatus incorporating its own vacuum and method and adapter for use therewith

U.S. Pat. No. 6,070,623 to Aneas entitled Connecting device in particular between a receptacle with a stopper capable of being perforated and a syringe

U.S. Pat. No. 6,382,442 to Thibault et al. entitled Plastic closure for vials and other medical containers

U.S. Pat. No. 6,478,788 to Aneas entitled Device for connection between a recipient and a container and ready-to-use assembly comprising such a device

U.S. Pat. No. 6,706,031 to Manera entitled Needleless access apparatus and system

U.S. Pat. No. 7,074,216 to Fowles et al. entitled Sliding reconstitution device for a diluent container

U.S. Pat. No. 7,195,623 to Burroughs et al. entitled Kit including side firing syringe needle for preparing a drug in an injection pen cartridge

U.S. Pat. No. 7,615,041 to Sullivan et al. entitled Vial adapter

U.S. Pat. No. 8,225,949 to Aneas entitled Plug device for a container and container provided with one such device

U.S. Pat. No. 8,480,646 to Nord et al. entitled Medical device connector

U.S. Pat. No. 8,562,582 to Tuckwell et al. entitled Reconstitution device

US Patent Application Publication No. 2012/0310203 entitled Apparatus and method

US Patent Application Publication No. 2013/0053814 entitled Device

There is a need for improved ready-to-use drug reconstitution assemblages including an open-topped drug container and a drug container closure mounted thereon.

### SUMMARY OF THE INVENTION

The present invention is directed toward drug container closures for mounting on an open-topped drug container to form a so-called ready-to-use drug reconstitution assemblage for use with a needleless syringe.

The drug container closures include three major components as follows: a closure housing for securely mounting on an open-topped drug container, a drug container stopper securely mounted on the closure housing for sealing the drug container, and a fluid transfer member slidingly mounted on the closure housing. The fluid transfer member includes a needleless syringe connector integrally formed with a puncturing cannula for puncturing the drug container stopper and in flow communication with the needleless syringe connector.

The closure housing preferably includes a diametric inverted L-shaped track pair for guiding downward displacement of the fluid transfer member from an initial non-puncturing position to a final puncturing position. Alternatively, closure housings can be designed with a single inverted L-shaped track or three or more inverted L-shaped tracks.

The inverted L-shaped tracks are configured to require a user to perform two actions for guiding a fluid transfer member from its initial non-puncturing position to its final puncturing position as follows: An initial minor clockwise rotation for priming the drug reconstitution assemblage ready for activation and a subsequent major activation displacement for puncturing a drug container stopper. The inverted L-shaped tracks ensure a secure path precluding inadvertent pre-puncturing and include one-way snap members to prevent a user returning the fluid transfer member to an earlier position thereby affording tamper evidence. The one-way snap members also afford audible user indications for indicating to proceed to the next user action.

The drug container closures can have closure housings with either open or closed inverted L-shaped tracks. The former requires an additional sheath for hermetically sealing a downward depending puncturing cannula. The latter requires an additional sleeve exterior mounted on the closure housing for sealing the open tracks thereby precluding the need for the additional sheath.

The fluid transfer members can be provided in a vented version or a non-vented version. The needleless syringe connectors can be formed as a female Luer connector. The needleless syringe connectors can be formed as a swabbable self-sealing port for multiple aspirations of liquid drug contents.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial representation of a first embodiment of a drug reconstitution assemblage in accordance with the present invention in an initial non-puncturing position for use with a needleless syringe;

FIG. 2 is a dissembled front elevation view of the FIG. 1 drug reconstitution assemblage;

FIG. 3 is a top elevation view of the FIG. 1 drug reconstitution assemblage;

FIG. 4 is a longitudinal cross section of the FIG. 1 drug reconstitution assemblage along line A-A in FIG. 3;

FIG. 5 is a longitudinal cross section of the FIG. 1 drug reconstitution assemblage along line B-B in FIG. 3;

FIG. 6 is an exploded front elevation view of the FIG. 1 drug reconstitution assemblage;

FIG. 7 is a longitudinal cross section of the FIG. 1 drug reconstitution assemblage along line C-C in FIG. 6;

FIG. 8 is a front elevation view of FIG. 6's fluid transfer member with integral needleless syringe connector and puncturing cannula;

FIG. 9 is a longitudinal cross section of the FIG. 8 fluid transfer member along line D-D thereon;

FIG. 10 is a longitudinal cross section of the FIG. 1 drug container closure's closure housing and the drug container stopper;

FIG. 11 is a longitudinal cross section of the FIG. 1 drug container closure in an initial non-puncturing position;

FIG. 12 is a longitudinal cross section of the FIG. 1 drug container closure being urged to a primed position ready for activation;

FIG. 13 is a longitudinal cross section of the FIG. 1 drug container closure in a final puncturing position;

FIGS. 14A to 14C show the use of the FIG. 1 drug reconstitution assemblage;

FIG. 15 is a front elevation view of a second embodiment of a drug reconstitution assemblage in accordance with the present invention in an initial non-puncturing position; and

FIG. 16 is a longitudinal cross section of the FIG. 15 drug reconstitution assemblage along line E-E thereon.

### DETAILED DESCRIPTION OF PREFERRED EMBODIMENTS OF THE INVENTION

FIG. 1 shows a ready-to-use drug reconstitution assemblage 100 for use with a needleless syringe 10 constituting a source of physiological fluid. The drug reconstitution assemblage 100 includes an open-topped drug container 20 constituted by an open-topped drug vial and a drug container closure 30 securely mounted thereon. The open-topped drug container 20 can be alternatively constituted by other medical containers and receptacles for storing powder or liquid drugs.

The syringe 10 includes a barrel 11 with a plunger 12 and a male Luer lock connector 13. The syringe 10 can be formed with other types of male connectors. The syringe 10 is filled with a liquid component 14. The liquid component 14 can be diluent only. Alternatively, the liquid component 14 can include an active component.

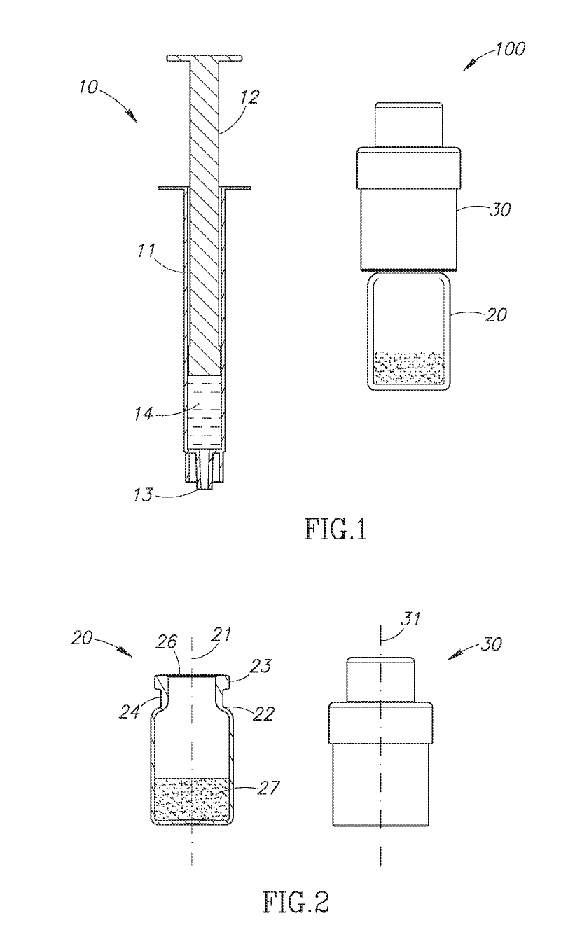

FIG. 2 shows the open-topped drug vial 20 has a longitudinal axis 21 and includes a drug vial shoulder 22, a drug vial rim 23 and an intermediate narrow drug vial neck 24. The drug vial rim 23 defines a drug vial opening 26. The drug vial 20 contains a powder or liquid drug 27.

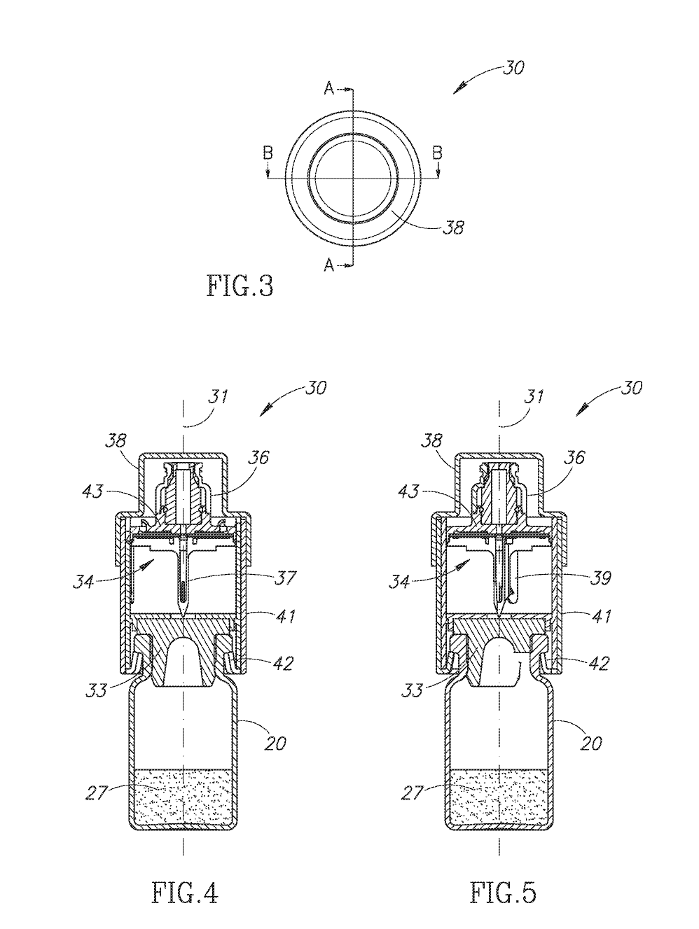

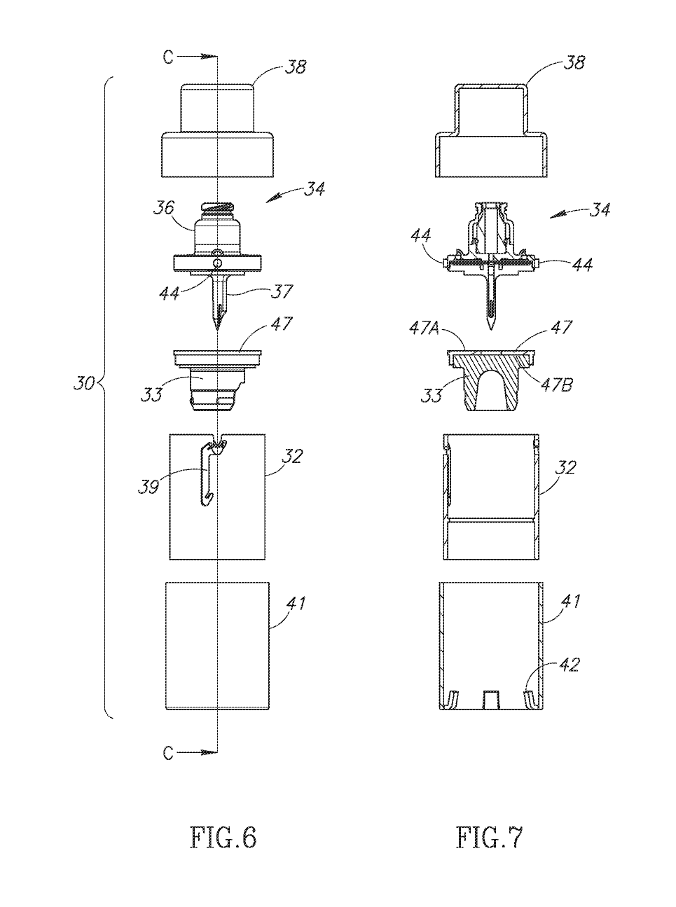

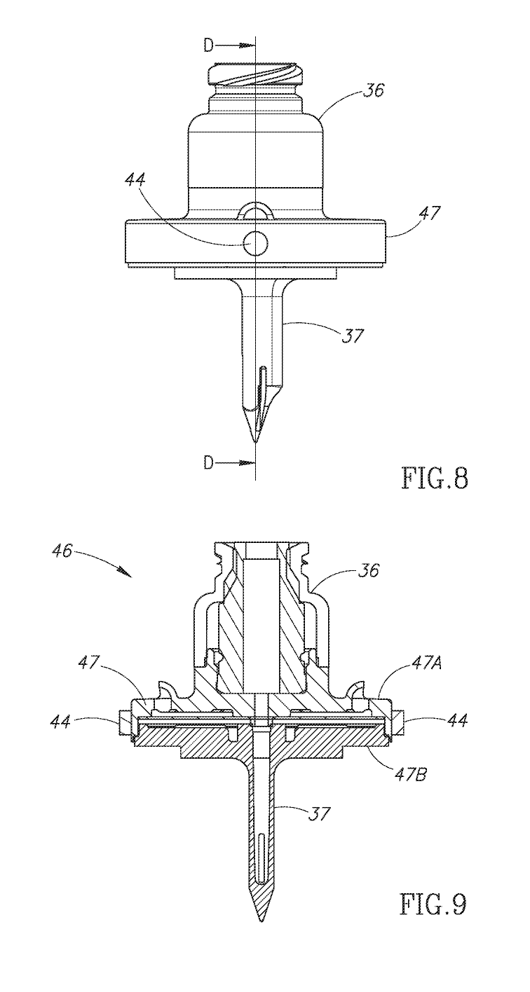

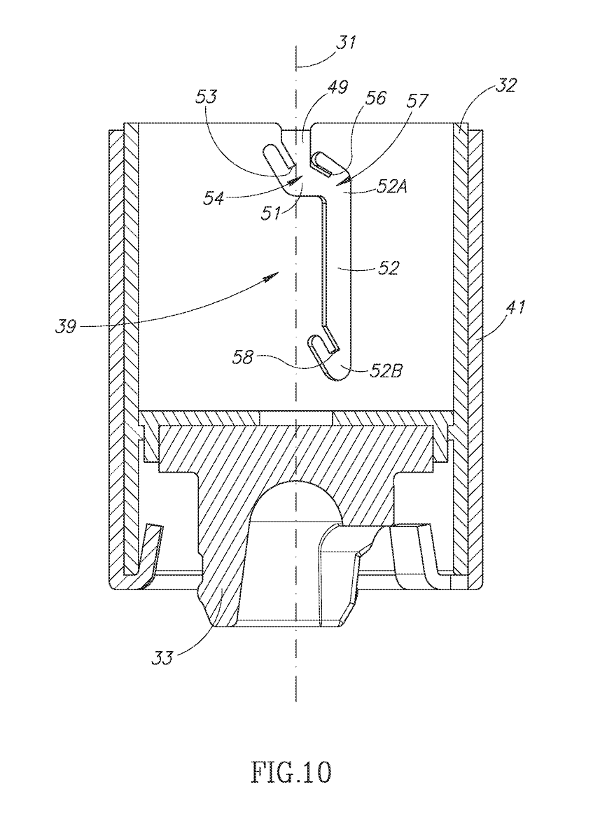

FIGS. 2 to 13 show the drug container closure 30 includes a longitudinal centerline 31 and a closure housing 32 for secure snap fit mounting on the drug vial 20 and a drug container stopper 33 for sealing the drug vial opening 26. The closure housing 32 accommodates a fluid transfer member 34 sliding displaceable from an initial non-puncturing position to a final puncturing position for puncturing the drug container stopper 33. The fluid transfer member 34 includes an integral needleless syringe connector 36 and a puncturing cannula 37 in flow communication with the syringe connector 36. The needleless syringe connector 36 is formed as a swabbable female Luer connector for screw thread mounting of a male connector 13 thereon. The drug container closure 30 includes a closure cap 38 for sealing the needleless syringe connector 36.

The closure housing 32 is made from suitable plastic material and includes a diametric inverted L-shaped track pair 39 for guiding activation displacement of the fluid transfer member 34 from its initial non-puncturing position to its final puncturing position. The drug container closure 30 includes a sleeve 41 exterior to the closure housing 32 for sealing the diametric inverted L-shaped track pair 39 to ensure sterility of the puncturing cannula 37. The sleeve 41 includes snap fit members 42 for snap fitting onto the drug vial rim 23 on downward depression of the drug container closure 30 onto the drug vial 20 during assembly of the ready-to-use drug reconstitution assemblage 100.

The fluid transfer member 34 includes a circular base member 43 formed with the needleless syringe connector 36 and the puncturing cannula 37. The base member 43 includes a diametrical outward directed pin pair 44 for travelling along the diametric inverted L-shaped track pair 39 for guided activation displacement of the fluid transfer member 34. The fluid transfer member 34 optionally includes a venting arrangement 46 as disclosed in commonly owned WIPO International Publication No. WO 2011/104712 entitled Liquid Drug Transfer Device with Vented Vial Adapter.

The closure housing 32 includes a cross member 47 having a cross member upperside 47A and a cross member underside 47B and formed with a central aperture 48 for passage therethrough of the puncturing cannula 37. The cross housing underside 47B is integrally formed with the drug container stopper 33. The cross member 47 and the drug container stopper 33 can be overmolded together. Alternatively, the cross member 47 can be mechanically attached to the drug container stopper 33, swaged thereto, adhered thereto, and the like.

The inverted L-shaped tracks 39 each include an open-ended upright access leg 49 co-directional with the longitudinal centerline 31, a horizontal priming leg 51 transverse to the longitudinal centerline 31, and an upright activation leg 52 co-directional with the longitudinal centerline 31. The major upright activation leg 52 has a proximal activation leg end 52A and a distal activation leg end 54B correspondingly adjacent and distal to the priming leg 51.

The inverted L-shaped tracks 39 also each include three one-way snap members as follows:

An one-way retaining snap member 53 at a juncture 54 between the opended upright access leg 49 and the horizontal priming leg 51. The one-way retaining snap member 53 retains the fluid transfer member 34 in the closure housing 32 before use.

An one-way primed snap member 56 at a juncture 57 between the horizontal priming leg 51 and the proximal activation leg end 52A.

An one-way activated snap member 58 at the distal activation leg end 52B.

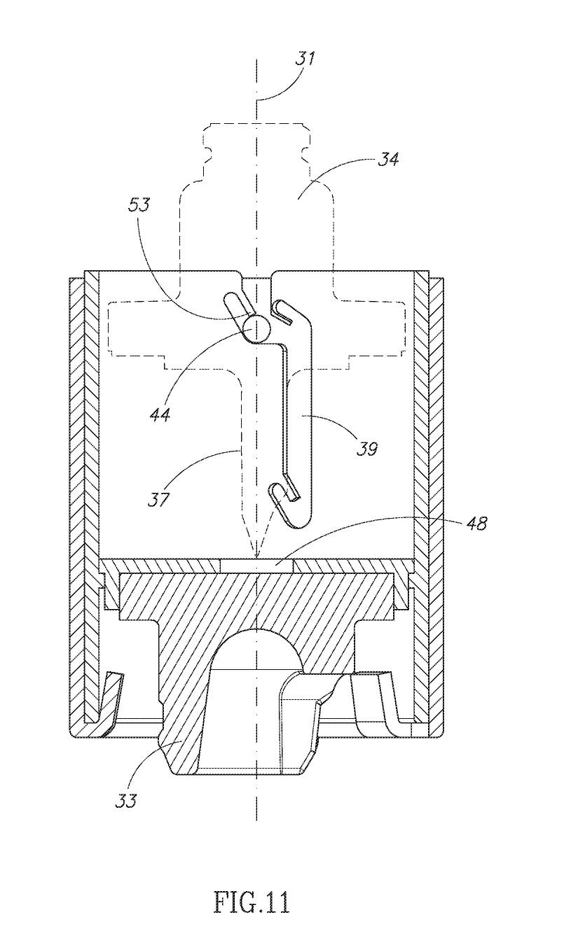

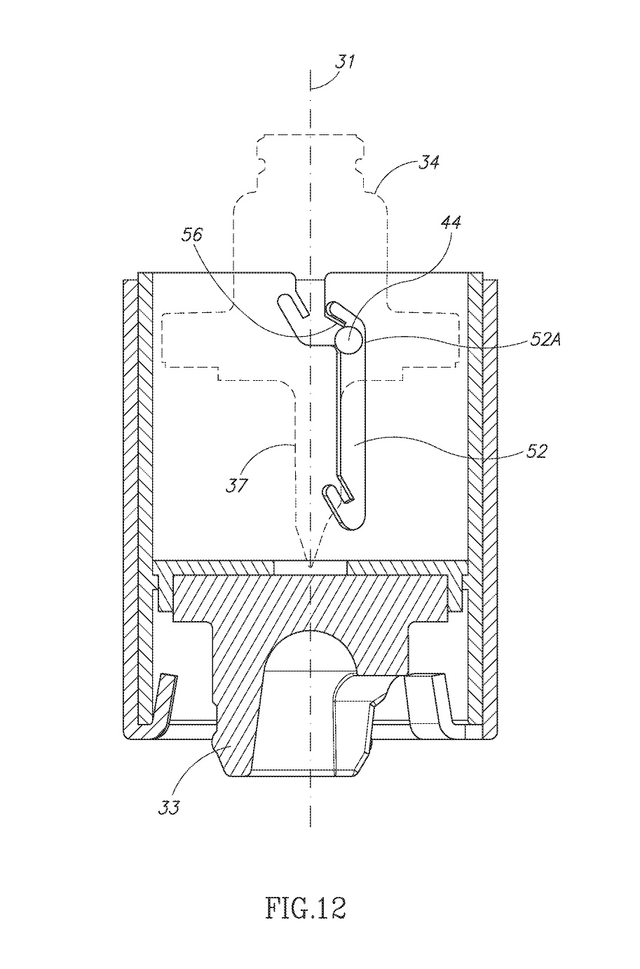

FIG. 11 shows the fluid transfer member 34 in its initial set-up position before use. The outward directed pin pair 44 are located along the horizontal priming leg pair 51 past the one-way retaining snap member pair 53 and before the one-way primed snap member pair 56. The puncturing cannula 36 is deployed above the central aperture 48 in position to puncture the drug container stopper 33.

FIG. 12 shows the fluid transfer member 34 being urged past the one-way primed snap member pair 56 to its primed position at the proximal activation leg end pair 52A ready for activation. This position is enabled by a user screw threading a needleless syringe 10 onto the drug reconstitution assemblage 100 and proceeding to rotate the needleless syringe 10 in a clockwise tightening direction until the outward directed pin pair 44 snap past the one-way primed snap member pair 56. The user hears a click as the outward directed pin pair 44 snap past the one-way primed snap member pair 56 for indicating that he can proceed with activation. The puncturing cannula 36 remains deployed above the central aperture 48 in position to puncture the drug container stopper 33. The one-way primed snap member pair 56 prevent the fluid transfer member 34 to be returned to the horizontal priming leg pair 51.

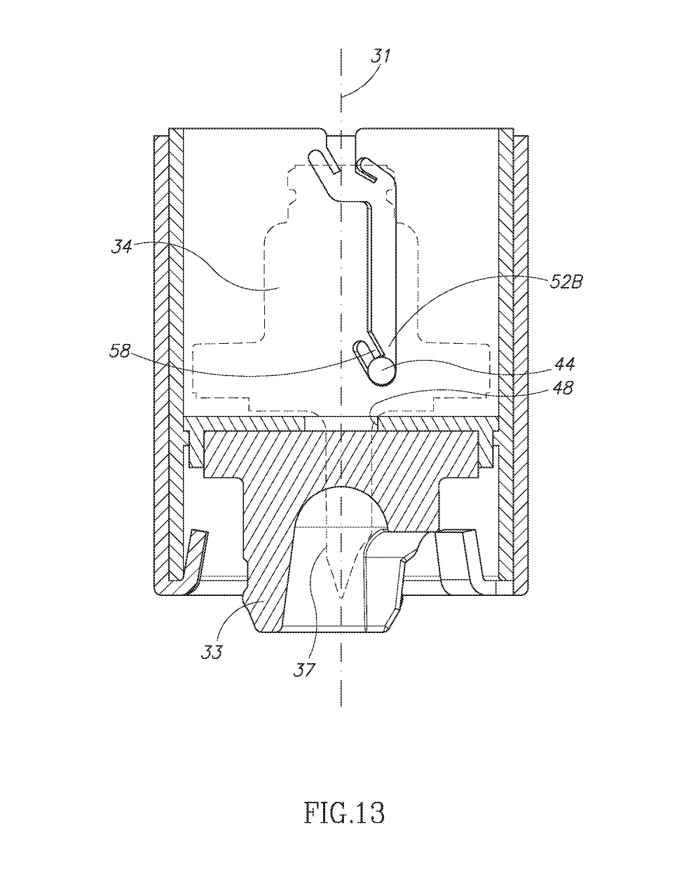

FIG. 13 shows the fluid transfer member 34 in its activated position at the distal activation leg end pair 52B. This position is enabled by a user depressing the needleless syringe 10 towards the drug vial 20 until the outward directed pin pair 44 snap past the one-way activated snap member pair 58. The user hears a click as the outward directed pin pair 44 snap past the one-way activated snap member pair 58 indicating that he can proceed with drug reconstitution and administration. The one-way activated snap member pair 58 prevent the fluid transfer member 34 to be returned to an earlier position.

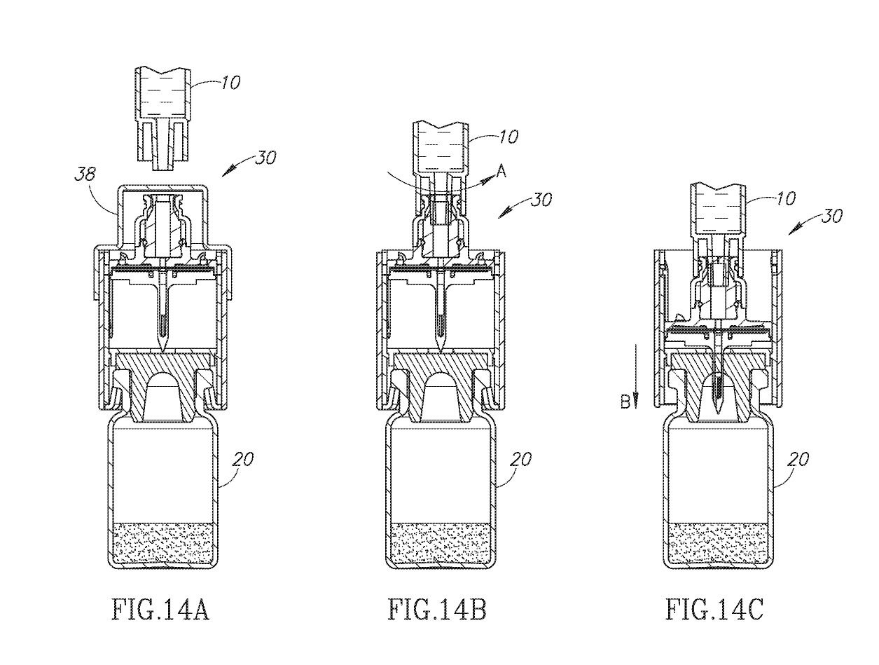

The use of the drug reconstitution assemblage 100 is now described with reference to FIGS. 14A to 14C as follows:

FIG. 14A shows the drug reconstitution assemblage 100 in its set-up position before use as shown in FIG. 11. A user removes the closure cap 38 from the drug reconstitution assemblage 100 to expose the needleless syringe connector 36.

FIG. 14B shows the user screw threading the needleless syringe 10 onto the needleless syringe connector 36 in a clockwise direction denoted by arrow A to initially seal the syringe 10 thereon and subsequently urge the fluid transfer member 34 to stop at the proximal activation leg end pair 52A as shown in FIG. 12. The user hears a click as the fluid transfer member 34 passes the one-way primed snap member pair 56 to indicate the drug reconstitution assemblage 100 is primed for activation.

FIG. 14C shows the user pushes the fluid transfer member 34 downwards along the activation legs 52 as denoted by arrow B to stop at the distal activation leg pair end 52B as shown in FIG. 13. The displacement causes the puncturing cannula 37 to puncture through the drug container stopper 33. The user hears a click as the fluid transfer member 34 passes the one-way activated snap member pair 58 to indicate he can proceed with drug reconstitution and administration.

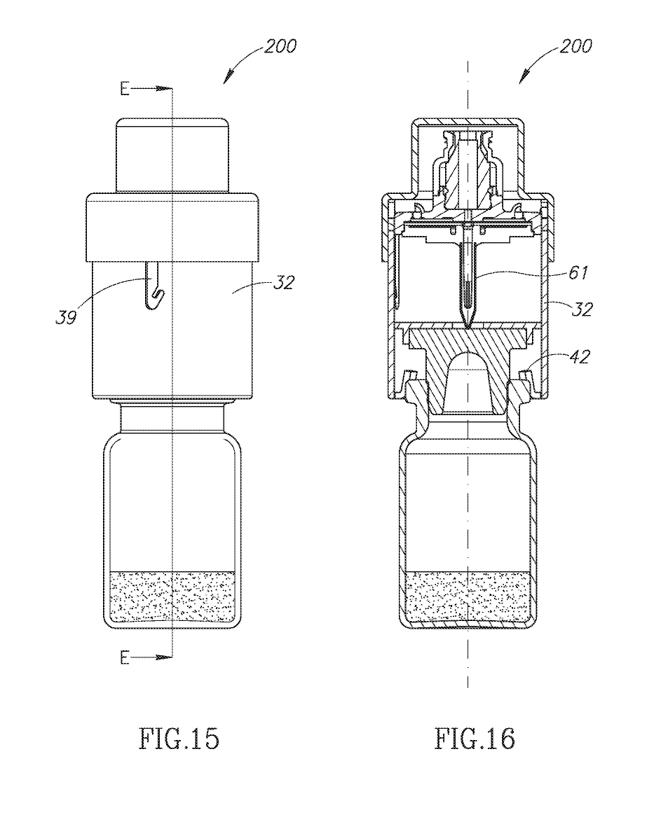

FIGS. 15 and 16 show a ready-to-use drug reconstitution assemblage 200 similar in construction and operation as the ready-to-use drug reconstitution assemblage 100 and therefore similar parts are likewise numbered. The latter 200 differs from the former 100 insofar as the latter 200 does not have the sleeve 41 and therefore its closure housing 32 is formed with the snap fit members 42 and has a diametric open inverted L-shaped track pair 39. The latter 200 includes a sheath 61 placed on the puncturing cannula 37 for ensuring sterility. The sheath 61 tears and is urged upwards against the cross member underside 48B on downward displacement of the fluid transfer member 34 to its final puncturing position.

While the invention has been described with respect to a limited number of embodiments, it will be appreciated that many variations, modifications, and other applications of the invention can be made within the scope of the appended claims.

1. A drug container closure for mounting on an open-topped drug container to form a ready-to-use drug reconstitution assemblage for use with a needleless syringe, the open-topped drug container having a drug container rim defining a drug container opening, the drug container closure having a longitudinal centerline and comprising:
(a) a tubular closure housing for securely mounting on the drug container rim, said closure housing including at least one inverted L-shaped track having an open-ended upright access leg, a horizontal priming leg and an upright activation leg, said activation leg having a proximal activation leg end and a distal activation leg end correspondingly adjacent and distal to said priming leg, each said inverted L-shaped track having:
i) an one-way retaining snap member between said open-ended upright access leg and said horizontal priming leg,
ii) an one-way primed snap member between said horizontal priming leg and said proximal activation leg end, and
iii) an one-way activated snap member towards said distal activation leg end;
(b) a drug container stopper securely mounted on said closure housing for sealing the drug container opening on securely mounting said closure housing on the drug container rim; and
(c) a fluid transfer member having an integral needleless syringe connector and a puncturing cannula in flow communication therewith, said needleless syringe connector for attachment of the needleless syringe thereto, said puncturing cannula for puncturing said drug container stopper,
said fluid transfer member being initially disposed along each said horizontal priming leg whereupon, on manual rotation of said fluid transfer member relative to said longitudinal centerline, said fluid transfer member is urged past each said one-way primed snap member to each said proximal activation leg end prior to being manually urged passed each said one-way activated snap member to each said distal activation leg end for puncturing said drug container stopper for flow communication with the drug container.

2. The closure according to claim 1 and further comprising a sleeve exterior to said closure housing for sealing each said inverted L-shaped track to ensure sterility of said puncturing cannula.

3. The closure according to claim 1 and further comprising a sheath on said puncturing cannula.

4. A ready-to-use drug reconstitution assemblage including an open-topped drug container and a drug container closure according to claim 1 mounted thereon.

5. A ready-to-use drug reconstitution assemblage including an open-topped drug container and a drug container closure according to claim 2 mounted thereon.

6. A ready-to-use drug reconstitution assemblage including an open-topped drug container and a drug container closure according to claim 3 mounted thereon.
